(19) United States
(12) Patent Application Publication
(10) Pub. No.: US 2026/0103009 A1
(43) Pub. Date: Apr. 16, 2026

(54) INKJET RECORDING APPARATUS

(71) Applicant: KYOCERA Document Solutions Inc., Osaka (JP)

(72) Inventor: Nobuhiro MAEZAWA, Osaka (JP)

(73) Assignee: KYOCERA Document Solutions Inc., Osaka (JP)

(21) Appl. No.: 19/349,234

(22) Filed: Oct. 3, 2025

(30) Foreign Application Priority Data
Oct. 16, 2024 (JP) 2024-180682

(51) Int. Cl. B41J 3/407; B41J 2/21; B41J 11/00; C09D 11/30; C09D 11/54

(52) U.S. Cl. CPC B41J 3/407; B41J 2/2103; B41J 11/0015; B41J 11/008; C09D 11/30; C09D 11/54

(57) ABSTRACT

An inkjet recording apparatus includes a conveyance portion, a recording portion, and a pretreatment liquid ejection head. The conveyance portion conveys a recording medium. The recording portion includes a recording head that ejects aqueous ink onto the recording medium conveyed thereto by the conveyance portion. The pretreatment liquid ejection head is arranged upstream of the recording portion in a conveyance direction of the recording medium and ejects a pretreatment liquid onto the recording medium by an inkjet method. The pretreatment liquid contains at least a binder resin and water. Where a resolution of the pretreatment liquid ejection head is indicated as A [dpi] and a resolution of the recording head is indicated as B [dpi], a relationship A<B is satisfied.

### INCORPORATION BY REFERENCE

This application is based upon and claims the benefit of priority from the corresponding Japanese Patent Application No. 2024-180682 (filed on Oct. 16, 2024), the entire contents of which are hereby incorporated by reference.

### BACKGROUND

The present disclosure relates to an inkjet recording apparatus that records an image by ejecting ink onto a recording medium.

As a recording apparatus such as a facsimile, a copy machine, or a printer, an inkjet recording apparatus that records an image by ejecting ink is widely known for its ability to form high-definition images.

In such an inkjet recording apparatus, it has become mainstream to use aqueous pigment ink that uses a pigment having excellent weatherability as a colorant. The aqueous pigment ink, however, has presented a problem that repelling or feathering of the ink is likely to occur when the ink is ejected onto a recording medium having low wettability, such as a plastic sheet.

### SUMMARY

An inkjet recording apparatus according to one aspect of the present disclosure includes a conveyance portion, a recording portion, and a pretreatment liquid ejection head. The conveyance portion conveys a recording medium. The recording portion includes a recording head that ejects aqueous ink onto the recording medium conveyed thereto by the conveyance portion. The pretreatment liquid ejection head is arranged upstream of the recording portion in a conveyance direction of the recording medium and ejects a pretreatment liquid onto the recording medium by an inkjet method. The pretreatment liquid contains at least a binder resin and water. Where a resolution of the pretreatment liquid ejection head is indicated as A [dpi] and a resolution of the recording head is indicated as B [dpi], a relationship A<B is satisfied.

### BRIEF DESCRIPTION OF THE DRAWINGS

FIG. 1 is a schematic view showing a structure of an inkjet recording apparatus.

FIG. 2 is an enlarged view of and around an application portion and a recording portion in FIG. 1.

FIG. 3 is a view showing a one-dot line image printed using aqueous ink at 600 dpi on a sheet to which a pretreatment liquid has not been applied.

FIG. 4 is a view showing a one-dot line image printed using the aqueous ink at 600 dpi on a sheet to which the pretreatment liquid has been applied.

FIG. 5 is a view schematically showing a state of ink droplets immediately after landing on a sheet and a state thereof after being dried in a case where the pretreatment liquid has not been applied to the sheet.

FIG. 6 is a view schematically showing a state of ink droplets immediately after landing on a sheet and a state thereof after being dried in a case where the pretreatment liquid has been applied to the sheet.

FIG. 7 is a view showing a missing dot checking chart including no missing dots.

FIG. 8 is a view showing a missing dot checking chart including missing dots.

### DETAILED DESCRIPTION

### [1. Pretreatment Liquid]

A pretreatment liquid used in the inkjet recording apparatus according to the present disclosure is used, when the inkjet recording apparatus forms an image using aqueous ink that contains a pigment dispersion containing a pigment and a resin, an organic solvent, and water, to adjust wettability of a plastic sheet as a recording medium so as to suppress repelling or feathering of the ink. The pretreatment liquid contains at least a binder resin and water. The pretreatment liquid may also contain a surfactant and/or a water-soluble organic solvent as required. The following describes in detail the pretreatment liquid used in the inkjet recording apparatus according to the present disclosure.

### (Binder Resin)

The binder resin is added so that wettability is imparted to the recording medium by the pretreatment liquid. This can suppress repelling of an ink droplet on the recording medium, which might occur when the recording medium has a low surface tension. The binder resin is preferably a urethane resin or a polyester resin. The urethane resin or the polyester resin blended into the pretreatment liquid is not particularly limited and can be appropriately selected depending on an intended purpose.

The urethane resin is, for example, a copolymerized product of a diol compound or a bisphenol compound and polyisocyanate.

Examples of the diol compound include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compound include bisphenol A, hydrogenated bisphenol A, bisphenol A ethylene oxide adducts (for example, polyoxyethylene (2,2)-2,2-bis(4-hydroxyphenyl) propane), and bisphenol A propylene oxide adducts.

Examples of the polyisocyanate include diisocyanate. Examples of the diisocyanate include aliphatic diisocyanate, alicyclic diisocyanate, and aromatic diisocyanate.

Examples of the aliphatic diisocyanate include ethylene diisocyanate, 2,2,4-trimethylhexamethylene diisocyanate, and 1,6-hexamethylene diisocyanate.

Examples of the alicyclic diisocyanate include hydrogenated 4,4′-diphenylmethane diisocyanate, 1,4-cyclohexane diisocyanate, methylcyclohexylene diisocyanate, isophorone diisocyanate, and norbornane diisocyanate.

Examples of the aromatic diisocyanate include 4,4′-diphenylmethane diisocyanate, xylylene diisocyanate, toluene diisocyanate, and naphthalene diisocyanate.

As the polyester resin, there can be used a polyester resin obtained by condensation polymerization or co-condensation polymerization of a dihydric or trihydric or higher alcohol component and a divalent or trivalent or higher carboxylic acid component. Examples of components used in synthesizing the polyester resin include alcohol components and carboxylic acid components listed below.

Specific examples of the dihydric or trihydric or higher alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylenated bisphenol A, and polyoxypropylenated bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methyl propanetriol, 2-methyl-1,2,4-butanetriol, trimethylolethane, trimethylolpropane, and 1,3,5-trihydroxymethylbenzene.

Specific examples of the divalent or trivalent or higher carboxylic acid component include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and alkyl or alkenyl succinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, or isododecenylsuccinic acid; and trivalent or higher carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empol trimer acid. These divalent or trivalent or higher carboxylic acid components may be used as ester-forming derivatives such as acid halides, acid anhydrides, and lower alkyl esters. The term “lower alkyl” used herein refers to an alkyl group having 1 to 6 carbon atoms.

In the pretreatment liquid, a content (a blended amount) of the binder resin is preferably not less than 5% by mass and more preferably not less than 5% by mass and not more than 20% by mass. In a case where a content of the polyester resin is less than 5% by mass, when the recording medium has a low wetting tension, a degree of wet spreading of ink thereon becomes insufficient.

### (Surfactant)

The surfactant is added to improve wettability of the pretreatment liquid with respect to the recording medium. An amount of the surfactant added is preferably 0.001% by mass to 5% by mass and more preferably 0.05% by mass to 2% by mass with respect to a total amount of the pretreatment liquid. When added in an amount of not less than 0.001% by mass, the surfactant provides an effect. It cannot be expected, however, that the effect is enhanced by adding the surfactant in an amount of more than 5% by mass.

As the surfactant, various types of surfactants are usable, such as a silicone-based surfactant, a non-ionic (nonionic) surfactant, an anionic surfactant, a cationic surfactant, and a betaine-based surfactant, and preferable among these is the non-ionic surfactant. As the non-ionic surfactant, an acetylene glycol-based surfactant having a symmetrical structure in which an acetylene group is positioned at the center is preferable in that it is unlikely to foam and is capable of imparting wettability. These types of surfactants may be used alone or in combination of two or more.

### (Water-Soluble Organic Solvent)

The water-soluble organic solvent is added to enhance compatibility with the binder resin and to retain moisture in the pretreatment liquid. Thus, even when the moisture in the pretreatment liquid evaporates in nozzles or an application device for the pretreatment liquid, an increase in viscosity of the pretreatment liquid is inhibited, so that even when the pretreatment liquid is applied by an inkjet process, the occurrence of nozzle misfiring, deflection of an ejection trajectory, or the like is suppressed, and thus ejection stability can be maintained.

Examples of the water-soluble organic solvent include polyhydric alcohols, polyhydric alcohol alkyl ethers, polyhydric alcohol aryl ethers, a nitrogen-containing heterocyclic compound, amides, amines, sulfur-containing compounds, propylene carbonate, and ethylene carbonate. Among these, preferable are those which have an equilibrium moisture content of not less than 30% by mass, and more preferable are those which have an equilibrium moisture content of not less than 40% by mass. Particularly preferable are the polyhydric alcohols, examples of which include ethylene glycol, polyethylene glycol, propylene glycol, dipropylene glycol, tripropylene glycol, polypropylene glycol, 3-methyl-1,3-butanediol, 1,5-pentanediol, 2-methyl-2,4-pentanediol, hexylene glycol, 1,6-hexanediol, 1,2,6-hexanetriol, trimethylolethane, trimethylolpropane, diethylene glycol, triethylene glycol, tetraethylene glycol, 1,3-butane diol, glycerin, diglycerin, 1,2,3-butanetriol, and 1,2,4-butanetriol. Among these, the propylene glycol and the 1,3-butane diol are particularly preferable in that they have a low viscosity when containing moisture, thus allowing the polyester resin used as the binder resin to be stably retained without being aggregated.

Specific examples of the polyhydric alcohol alkyl ethers include ethylene glycol monoethyl ether, ethylene glycol monobutyl ether, diethylene glycol monomethyl ether, diethylene glycol monoethyl ether, diethylene glycol monobutyl ether, ethylene glycol mono-2-ethylhexyl ether, and propylene glycol monoethyl ether. Specific examples of the polyhydric alcohol aryl ethers include ethylene glycol monophenyl ether and ethylene glycol monobenzyl ether. Specific examples of the nitrogen-containing heterocyclic compound include 2-pyrrolidone, N-methyl-2-pyrrolidone, 1,3-dimethyl-2-imidazolidinone, ε-caprolactam, and γ-butyrolactone.

While not particularly limited, an amount of the water-soluble organic solvent added is preferably 5% by mass to 40% by mass and more preferably 10% by mass to 30% by mass with respect to the total amount of the pretreatment liquid. When the amount of the water-soluble organic solvent added is 5% by mass to 40% by mass, the pretreatment liquid can retain sufficient moisture and is not too high in viscosity, and thus it is possible to effectively apply the pretreatment liquid to the recording medium.

### (Water)

The pretreatment liquid used in the present disclosure is aqueous and thus contains water as an essential component. The water contained in the pretreatment liquid is not particularly limited as long as an object of the present disclosure is not impaired, and water having a desired purity can be appropriately selected and employed from among purified water, ion-exchanged water, and so on. A content of the water in the pretreatment liquid is not particularly limited as long as the object of the present disclosure is not impaired and is appropriately changed depending on amounts of after-mentioned other components used. The content of the water in the pretreatment liquid is preferably 50% by mass to 90% by mass with respect to a total mass of the pretreatment liquid.

Furthermore, as required, the pretreatment liquid used in the present disclosure may contain materials known to be used in pretreatment liquids, such as a foam inhibitor, a pH adjuster, an antiseptic-antifungal agent, and an antirust agent.

### (Foam Inhibitor)

The foam inhibitor is added to inhibit foaming of the pretreatment liquid. Generally, while a liquid having a high surface tension, such as water, is unlikely to foam since a force for minimizing a surface area of the liquid acts thereon, a liquid having a low surface tension and a high viscosity is likely to foam, and resulting bubbles hardly dissipate. The pretreatment liquid according to the present disclosure, when containing the binder resin, the water-soluble organic solvent, the surfactant, and so on, has a decreased surface tension and an increased viscosity and thus becomes likely to foam, for which reason the foam inhibitor is preferably added thereto. An amount of the foam inhibitor added is preferably 0.01% by mass to 10% by mass and more preferably 0.02% by mass to 5% by mass. A sufficient effect of inhibiting foaming is obtained when the foam inhibitor is added in an amount of not less than 0.01% by mass. Furthermore, when the foam inhibitor is added in an amount of not more than 10% by mass, there is no risk of the foam inhibitor becoming insoluble in the pretreatment liquid.

### (PH Adjuster)

The pH adjuster is not particularly limited as long as it can adjust the pretreatment liquid to have a pH of 6 to 10 without having an adverse effect thereon and can be appropriately selected depending on an intended purpose. When the pH is not less than 6, corrosion is unlikely to occur in a conveyance member that contacts the pretreatment liquid, such as a conveyance roller.

Preferable examples of the pH adjuster include alcohol amines, hydroxides of alkali metals, hydroxides of ammonium, hydroxides of phosphonium, and carbonates of alkali metals. Examples of the alcohol amines include diethanolamine, triethanolamine, and 2-amino-2-ethyl-1,3-propanediol. Examples of the hydroxides of alkali metals include lithium hydroxide, sodium hydroxide, and potassium hydroxide. Examples of the hydroxides of ammonium include ammonium hydroxide and quaternary ammonium hydroxide. Examples of the hydroxides of phosphonium include quaternary phosphonium hydroxide. Examples of the carbonates of alkali metals include lithium carbonate, sodium carbonate, and potassium carbonate.

### (Antiseptic-Antifungal Agent)

Examples of the antiseptic-antifungal agent that can be favorably used include sodium dehydroacetate, sodium sorbate, sodium 2-pyridinethiol-1-oxide, sodium benzoate, sodium pentachlorophenol, and 1,2-benzoisothiazoline-3-one sodium.

### (Antirust Agent)

Examples of the antirust agent that can be favorably used include acidic sulfite, sodium thiosulfate, ammonium thiodiglycolate, diisopropylammonium nitrite, dicyclohexylammonium nitrite, pentaerythritol tetranitrate, and 1,2,3-benzotriazole.

The pretreatment liquid according to the present disclosure obtained as described above is applied by an inkjet method to the recording medium before being subjected to recording using aqueous ink (pigment ink) so that wettability (a wetting tension) of a surface of the recording medium is improved. This can suppress repelling or feathering of the aqueous ink ejected onto the recording medium.

While an amount of the pretreatment liquid applied is not particularly limited, when the amount is smaller than 1 g/m², the wettability (the wetting tension) of the surface of the recording medium cannot be sufficiently improved, and this results in an insufficient effect of suppressing repelling or feathering of the aqueous ink. On the other hand, when the amount is more than 20 g/m², the wettability of the surface of the recording medium is excessively increased, and the pretreatment liquid fails to be dried in time, so that there is a possibility that feathering of the aqueous ink occurs. Accordingly, the amount of the pretreatment liquid applied is preferably not less than 1 g/m² and not more than 20 g/m² and more preferably not less than 5 g/m² and not more than 10 g/m².

### [2. Image Recording Method]

Next, a description is given of an image recording method using an inkjet recording apparatus. The inkjet recording apparatus used in the image recording method according to the present disclosure is not particularly limited, and there is used an inkjet recording apparatus of a serial head type or a line head type. While particularly in an inkjet recording apparatus using aqueous pigment ink, repelling or feathering of the ink is likely to occur when a plastic sheet is used as the recording medium, according to the image recording method of the present disclosure, these problems are unlikely to occur.

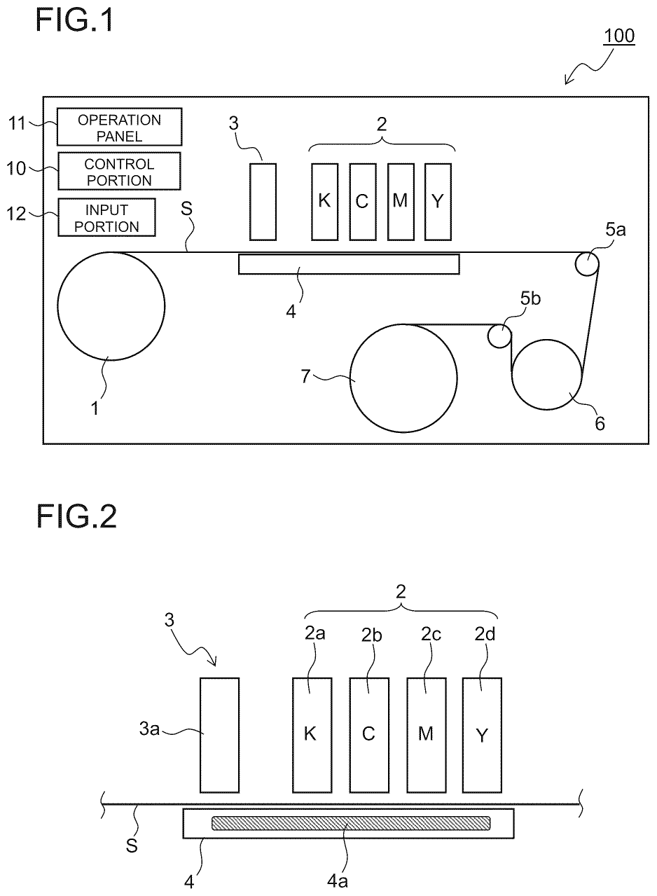

FIG. 1 is a schematic view showing a structure of an inkjet recording apparatus 100 according to one embodiment of the present disclosure. FIG. 2 is an enlarged view of and around a recording portion 2 and an application portion 3 in FIG. 1. As shown in FIG. 1, the inkjet recording apparatus 100 includes a sheet feed-out portion 1, the recording portion 2, the application portion 3, a conveyance plate 4, a heating drum 6, a sheet winding portion 7, a control portion 10, an operation panel 11, and an input portion 12.

A sheet S that is an elongated printing base material (herein, a plastic sheet) is placed in the sheet feed-out portion 1 provided upstream of the recording portion 2 in a conveyance direction (on a left side in FIG. 1). The sheet feed-out portion 1 includes a rotary shaft to which the sheet S in a roll shape is mounted and a motor that drives the rotary shaft to rotate in a prescribed rotation direction (neither of these is shown). As the rotary shaft rotates through driving of the motor, the sheet S is fed out downstream in the conveyance direction (to a right side in FIG. 1).

The recording portion 2 includes recording heads 2a, 2b, 2c, and 2d (see FIG. 2). The recording heads 2a to 2d are supplied respectively with ink of four different colors (yellow, magenta, cyan, and black) stored in ink tanks (not shown). The recording portion 2 uses the recording heads 2a to 2d to record an image on the sheet S fed out from the sheet feed-out portion 1.

The application portion 3 is arranged upstream of the recording portion 2 in a sheet conveyance direction (the left side in FIG. 1). The application portion 3 includes a pretreatment liquid ejection head 3a. The pretreatment liquid ejection head 3a is identical in structure to the recording heads 2a to 2d and ejects the aforementioned pretreatment liquid, by the inkjet method, onto the sheet S fed out from the sheet feed-out portion 1.

The conveyance plate 4 is arranged below the recording portion 2 and the application portion 3. The sheet S fed out from the sheet feed-out portion 1 is supported, by the conveyance plate 4, at a prescribed distance from the recording portion 2 and the application portion 3. The conveyance plate 4 is equipped with a heater 4a arranged on a rear surface side thereof (on an opposite side to the recording portion 2 and the application portion 3). While being conveyed along the conveyance plate 4, the sheet S is heated from a rear surface side thereof by the heater 4a. Thus, before the ink is ejected by the recording portion 2, the pretreatment liquid that has been ejected onto the sheet S at the application portion 3 is dried. The heater 4a may be of any type among a halogen heater, a ceramic heater, a high-frequency induction heater (IH), a hot water heater, and so on.

The sheet S that has passed through the recording portion 2, after its conveyance direction is changed by a guide roller 5a, is conveyed to the heating drum 6. When the sheet S contacts the heating drum 6, the ink on the sheet S is dried and fixed thereto. The sheet S to which the ink has been fixed, after its conveyance direction is changed by a guide roller 5b, is wound in a roll shape at the sheet winding portion 7. While in this embodiment, the heating drum 6 is used to dry the ink, any other heating device such as an infrared dryer or a warm air dryer may be used.

In accordance with image data received from an external computer, the control portion 10 controls ink ejection at the recording portion 2. Furthermore, as will be described later, in accordance with the image data, the control portion 10 determines an ejection target region to which the pretreatment liquid is to be ejected at the application portion 3.

The operation panel 11 functions as a touch panel for a user to perform various types of settings for the inkjet recording apparatus 100 and inputting thereto, and displays a state of the inkjet recording apparatus 100, an image recording status, the number of sheets printed, and so on.

The input portion 12 receives image data from an external apparatus such as a personal computer. Based on the image data received at the input portion 12, the control portion 10 controls ink ejection onto the sheet S by the recording portion 2 so that a prescribed image is recorded on the sheet S. In a case where the inkjet recording apparatus 100 has an image reading function (a scanner function), an image reading portion also functions as the input portion 12.

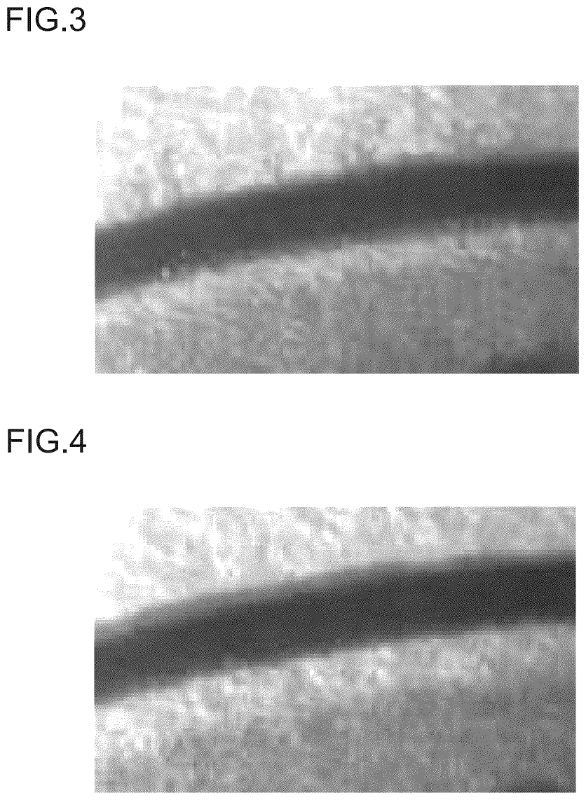

FIG. 3 is a view showing an image printed using aqueous ink at 600 dpi on the sheet

S to which the pretreatment liquid has not been applied. FIG. 4 is a view showing an image printed using the aqueous ink at 600 dpi on the sheet S to which the pretreatment liquid has been applied.

As shown in FIG. 3, in a case of not applying the pretreatment liquid to the sheet S, at boundary portions of colors, color mixing occurred, rendering boundaries between the colors unclear. On the other hand, as shown in FIG. 4, in a case of applying the pretreatment liquid to the sheet S, no color mixing occurred, and thus the boundaries between the colors were kept clear.

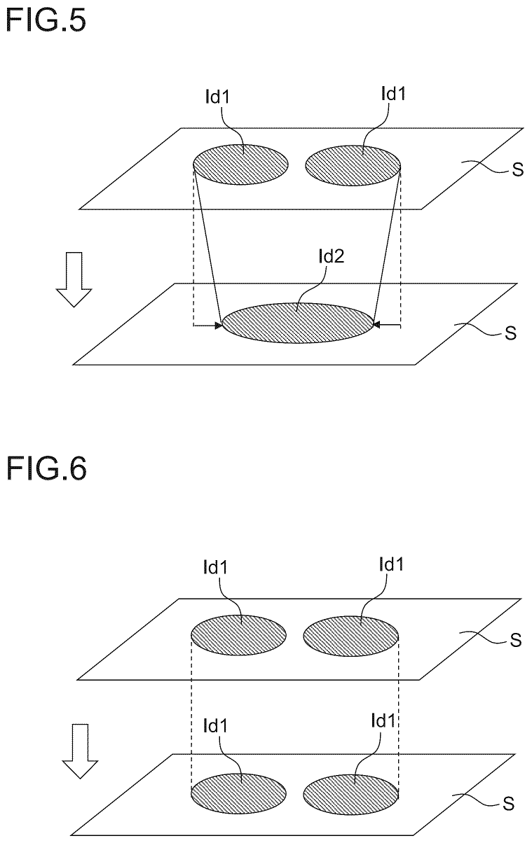

FIG. 5 is a view schematically showing a state of ink droplets immediately after landing on the sheet S and a state thereof after being dried in a case where the pretreatment liquid has not been applied to the sheet S, and FIG. 6 is a view schematically showing those states in a case where the pretreatment liquid has been applied to the sheet S. As shown in FIG. 5, in the case where the pretreatment liquid has not been applied to the sheet S, so that the sheet S has a low wetting tension, in some areas, adjacently ejected ink droplets Id1 might be attracted to each other to form (coalesce into) a single large ink droplet Id2. This causes nonuniformity in size of ink droplets, and, as shown in FIG. 3, color mixing occurs, rendering boundaries between colors unclear.

On the other hand, as shown in FIG. 6, in the case where the pretreatment liquid has been applied to the sheet S, so that the sheet S has an increased wetting tension, there occurs no coalescence of the ink droplets Id1, causing no variation in size of ink droplets. Accordingly, as shown in FIG. 4, no color mixing occurs, and thus the boundaries between the colors are kept clear. In a case where a plastic sheet as described above is used as the sheet S, by applying the pretreatment liquid thereto, it is possible to adjust a wetting tension of the sheet S to be in an optimum range so as to suppress feathering or repelling of the ink, thus improving printing performance.

There has been a problem that it takes a long time to dry the pretreatment liquid applied to the sheet S. There has also been a problem that when the pretreatment liquid is reduced in moisture content so that a required drying time is reduced, applying such a highly concentrated pretreatment liquid is likely to cause nozzle clogging in the pretreatment liquid ejection head 3a.

As a solution thereto, in the inkjet recording apparatus 100 according to this embodiment, where a resolution of the pretreatment liquid ejection head 3a for applying the pretreatment liquid is indicated as A [dpi] and a resolution of the recording heads 2a to 2d for ejecting the ink is indicated as B [dpi], a relationship A<B is established. In this manner, the resolution A of the pretreatment liquid ejection head 3a for applying the pretreatment liquid is set to be smaller than the resolution B of the recording heads 2a to 2d for ejecting the ink, and this enables ejection of a highly concentrated (highly viscous) pretreatment liquid whose moisture content is reduced. As a result, it is possible to reduce the time required to dry the pretreatment liquid and thus to achieve both productivity and formation of good images.

Furthermore, when the resolution A of the pretreatment liquid ejection head 3a is set to be smaller, a nozzle diameter for ejecting the pretreatment liquid is increased. As a result, it is possible to suppress nozzle clogging resulting from use of a highly concentrated pretreatment liquid. Furthermore, when the resolution B of the recording heads 2a to 2d is set to be larger, high-resolution clear images can be formed. As a result, it is possible to suppress collapse of a complicated character such as a Chinese character “Todoroki” when printed in a small font.

Inkjet heads in general use have a resolution of 300 dpi, 600 dpi, or 1200 dpi. Accordingly, in the inkjet recording apparatus 100 according to this embodiment, possible three combinations of the resolutions A and B are a combination of the resolution A of 300 dpi and the resolution B of 600 dpi, a combination of the resolution A of 300 dpi and the resolution B of 1200 dpi, and a combination of the resolution A of 600 dpi and the resolution B of 1200 dpi.

When the resolution A is decreased, the nozzle diameter of the pretreatment liquid ejection head 3a is increased, in which case, while nozzle clogging in the pretreatment liquid ejection head 3a becomes unlikely to occur, droplets of the pretreatment liquid are increased in size. As a result, the time required to dry the pretreatment liquid is increased. On the other hand, when the resolution B is decreased, a nozzle diameter of the recording heads 2a to 2d is increased, in which case, ink droplets are increased in size. As a result, collapse of a small-font character becomes likely to occur.

From the above-described viewpoint, the resolution B is preferably 1200 dpi. Furthermore, a particularly preferable combination of the resolutions A and B is the combination of the resolution A of 600 dpi and the resolution B of 1200 dpi.

The viscosity of the pretreatment liquid is preferably not less than 6.0 [mPa·s] and not more than 7.0 [mPa·s]. When the viscosity of the pretreatment liquid is less than 6.0 [mPa·s], while nozzle clogging in the pretreatment liquid ejection head 3a becomes unlikely to occur, the drying time required to dry the pretreatment liquid is increased due to an increased moisture content. On the other hand, when the viscosity of the pretreatment liquid is more than 7.0 [mPa·s], while the drying time required to dry the pretreatment liquid is reduced thanks to a decreased moisture content, a tolerance (a margin) of nozzles of the pretreatment liquid ejection head 3a with respect to dryness of the pretreatment liquid is lost, and thus nozzle clogging becomes likely to occur. Furthermore, it becomes likely that the pretreatment liquid reacts with ink mist and thus is cured.

Furthermore, based on image data received from an external computer by the input portion 12, the control portion 10 detects a printing target region (an ink ejection target region) on the sheet S. The control portion 10 performs control so that, using the pretreatment liquid ejection head 3a, the pretreatment liquid is ejected only to the printing target region on the sheet S thus detected. In this manner, the pretreatment liquid is ejected only to the printing target region, and thus it is possible to inhibit ejection of the pretreatment liquid to a non-printing target region not requiring ejection of the pretreatment liquid thereto and thus to reduce a consumption amount of the pretreatment liquid. As a result, it is possible to suppress running costs of the inkjet recording apparatus 100.

According to the image recording method described thus far, the pretreatment liquid containing a binder resin is applied to a sheet before being subjected to image formation using aqueous pigment ink by the inkjet recording apparatus 100. Thus, it is possible to increase wettability (a wetting tension) of the sheet so as to suppress repelling or feathering of the aqueous ink and thus to improve image quality. The image recording method according to the present disclosure is, therefore, favorably usable in various types of inkjet recording apparatuses using aqueous ink.

In addition, the present disclosure is not limited to the foregoing embodiment and can be variously modified within the scope of the claims. For example, while there has been described, with reference to FIG. 1, the inkjet recording apparatus 100 that ejects ink onto an elongated sheet wound in a roll shape and being fed out at a prescribed speed, the present disclosure is similarly applicable also to an inkjet recording apparatus of a type that ejects ink onto a sheet cut in a prescribed shape.

Furthermore, a material of the recording medium is also not limited to a plastic film, and there can be used various types of recording media including paper sheets such as a plain sheet or a coated sheet, fabric such as woven fabric, knitted fabric, or nonwoven fabric of natural or synthetic fibers, and so on. While the following more specifically describes effects of the present disclosure by way of examples, the present disclosure is not restricted to the examples.

### EXAMPLES

### Production Example 1

### (Preparation of Pigment Dispersion)

With 775 g of ion-exchanged water, 75 g of a pigment dispersion resin (DISPERBYK-190 manufactured by BYK Japan KK, nonvolatile content: 40% by mass, dispersion medium: water) was diluted, and 150 g of a pigment (Pigment Blue 15:03) was added thereto, after which a resulting mixture was preliminarily mixed using a homogenizing disperser at a rotational speed of 5000 rpm for 1 hour. After that, the mixture was subjected to a dispersion treatment using a bead mill (manufactured by Nippon Coke & Engineering Co., Ltd.), and thus a pigment dispersion was obtained. In this case, zirconia beads (0.2 mmφ) were filled in a vessel at a filling ratio of 80% with respect to a capacity of the vessel. A Z-average dispersed particle diameter obtained was 101 nm.

### Production Example 2

### (Preparation of Ink)

Pigment ink was prepared by mixing 5% by mass of the pigment dispersion obtained in Production Example 1, 3% by mass of a urethane resin (HA560 manufactured by Nicca Chemical Co., Ltd.), 0.05% by mass of a surfactant (SAG-502A manufactured by Nissin Chemical Industry Co., Ltd.), 25% by mass of propylene glycol, 8% by mass of butyl triglycol, and 58.95% by mass of water.

### Production Example 3

### [Preparation of Pretreatment Liquid]

A pretreatment liquid 1 was prepared by stirring, using a stirrer, 8% by mass of a urethane resin (HA560 manufactured by Nicca Chemical Co., Ltd.), 0.05% by mass of a surfactant (Surfynol 440 manufactured by Nissin Chemical Industry Co., Ltd.), 25% by mass of propylene glycol, 8% by mass of butyl triglycol, and 58.95% by mass of water.

Pretreatment liquids 2 to 4 were prepared by a similar method to the method for preparing the pretreatment liquid 1 except that a blended amount of the urethane resin was made to vary. Table 1 shows respective viscosities and compositions of the pigment ink and the pretreatment liquids 1 to 4.

TABLE 1

| | | Pigment | Pretreatment Liquid | | | |
|---|---|---|---|---|---|---|
| | | Ink | 1 | 2 | 3 | 4 |
| Viscosity [mPa · s] | | 5.5 | 5.5 | 6.0 | 7.0 | 7.5 |
| Component | Pigment | 5 | 0 | 0 | 0 | 0 |
| [% by mass] | Dispersion | | | | | |
| | Urethane Resin | 3 | 8 | 11 | 17 | 20 |
| | Surfactant | 0.05 | 0.05 | 0.05 | 0.05 | 0.05 |
| | Water | 58.95 | 58.95 | 55.95 | 49.95 | 46.95 |
| | Propylene Glycol | 25 | 25 | 25 | 25 | 25 |
| | Butyl Triglycol | 8 | 8 | 8 | 8 | 8 |

### [Evaluations of Nozzle Clogging, Drying Time, and Collapse of Small-Font Character]

The pigment ink (cyan ink) obtained in Production Example 2 and the pretreatment liquids 1 to 4 (hereinafter, may be referred to collectively as the pretreatment liquid) obtained in Production Example 3 were used to evaluate nozzle clogging of a pretreatment liquid ejection head, a drying time required to dry the pretreatment liquid, and collapse of a small-font character when printed. A test apparatus used for evaluations includes a single inkjet head (KJ4B-YH manufactured by Kyocera Corporation) for ejecting the pigment ink, another single inkjet head of the same type for ejecting the pretreatment liquid, and a conveyance table provided below the inkjet heads to convey a printing base material (a sheet). The conveyance table is configured to be heatable to a prescribed temperature. Furthermore, a drying portion is provided downstream of the inkjet heads. The drying portion is configured to blow hot air to the printing base material, thus drying the pretreatment liquid and the ink.

System conditions used were a head application voltage of 21 V, a drive frequency of 20 kHz, an amount of ejected liquid droplets of 3 pl, a temperature of the pretreatment liquid ejection head and a recording head of 32° C., and the number of times of pre-ejection flushing of 1000, and the conveyance table for conveying the printing base material was previously heated to 40° C. The printing base material was conveyed at a conveyance speed of 30 m/minute. A plastic sheet was used as the printing base material.

### <Nozzle Clogging>

The pretreatment liquid was fed to the pretreatment liquid ejection head and let stand for 1 hour. After being let stand for 1 hour, the pretreatment liquid was ejected through all nozzles onto a sheet of thermosensitive paper, and thus a missing dot checking chart was printed. Such a sheet of thermosensitive paper onto which a pretreatment liquid has been ejected turns black as a result of a reaction with alcohols contained as a water-soluble organic solvent in the pretreatment liquid. Based on this, a visual examination was performed on the sheet of thermosensitive paper for presence or absence of white voids to determine whether or not there were missing dots (misfiring nozzles).

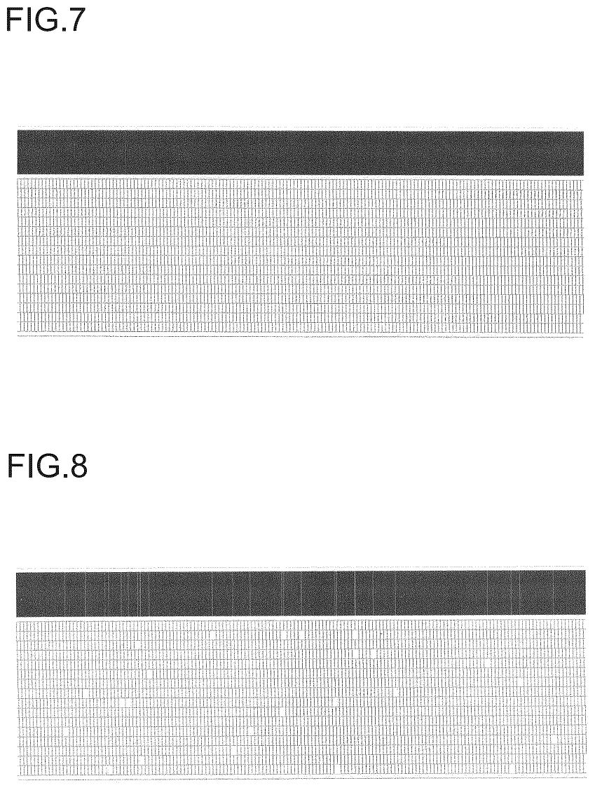

FIG. 7 is a view showing a missing dot checking chart including no missing dots, and FIG. 8 is a view showing a missing dot checking chart including missing dots. Each of the missing dot checking charts is composed of a lateral belt-shaped solid image on an upper side on a sheet and a grid image of longitudinal and lateral lines formed below and adjacently to the solid image.

In a case of including no missing dots, as shown in FIG. 7, there are also no white streaks on the solid image, and the lines of the grid image are formed at even intervals. On the other hand, in a case of including missing dots, as shown in FIG. 8, white streaks are observed on the solid image, and the longitudinal lines of the grid image are partially missing.

In a case where missing dots were observed, after execution of an operation of purging (extruding) the pretreatment liquid, ejection thereof was performed again to determine whether or not there were missing dots. Further, an evaluation was performed based on evaluation criteria below.

### (Evaluation Criteria)

G: No missing dots were observed even without purging of the pretreatment liquid.
F: While missing dots occurred when ejection was performed without purging of the pretreatment liquid, no missing dots were observed after the purging of the pretreatment liquid.
P: Missing dots occurred even after purging of the pretreatment liquid.

### <Drying Time>

Hot air at 80° C. was blown to a printing medium onto which the pretreatment liquid had been ejected, and a drying time required to dry the pretreatment liquid was measured. Further, an evaluation was performed based on evaluation criteria below.

### (Evaluation Criteria)

G: The pretreatment liquid was dried within 10 seconds.
F: The pretreatment liquid was dried within 15 seconds.
P: The drying time required was more than 15 seconds.

### <Collapse of Small-Font Character>

Using the above-described test apparatus, a Chinese character “Todoroki” in font size 3 was printed at varying respective resolutions of the pretreatment liquid ejection head and the recording head. On printed matter thus obtained, a visual evaluation of character collapse was performed based on evaluation criteria below.

### (Evaluation Criteria)

G: No character collapse was observed.
P: Character collapse was observed.

Table 2 shows results of the evaluations of nozzle clogging, the drying time, and collapse of a small-font character along with respective resolutions of the inkjet head for ejecting the pretreatment liquid and the inkjet head for ejecting the ink and the viscosity of the pretreatment liquid.

TABLE 2

| | | | Pretreatment | | | |
|---|---|---|---|---|---|---|
| | Resolution [dpi] | | Liquid | Results | | |
| | Pretreatment | | Viscosity | Nozzle | Drying | Character |
| | Liquid | Ink | [mPa · s] | Clogging | Time | Collapse |
| Disclosure Example 1 | 600 | 1200 | 7.0 | G | G | G |
| Disclosure Example 2 | 600 | 1200 | 6.0 | G | G | G |
| Disclosure Example 3 | 600 | 1200 | 5.5 | G | F | G |
| Disclosure Example 4 | 600 | 1200 | 7.5 | F | G | G |
| Comparative Example 1 | 600 | 600 | 7.0 | G | G | P |
| Comparative Example 2 | 1200 | 1200 | 7.0 | P | G | G |

As is apparent from Table 2, in cases where the inkjet head for ejecting the pretreatment liquid had a resolution of 600 dpi and the inkjet head for ejecting the ink had a resolution of 1200 dpi (Disclosure Examples 1 to 4), no missing dots were observed even without purging of the pretreatment liquid or no missing dots were observed after the purging of the pretreatment liquid. Furthermore, also in these cases, the pretreatment liquid was dried within 15 seconds, and no collapse of a small-font character was observed.

Particularly in Disclosure Examples 1 and 2 in which the pretreatment liquid had a viscosity of not less than 6.0 [mPa·s] and not more than 7.0 [mPa·s], no missing dots were observed even without purging of the pretreatment liquid, and the pretreatment liquid was dried within 10 seconds.

In contrast, in Comparative Example 1 in which the inkjet head for ejecting the pretreatment liquid and the inkjet head for ejecting the ink both had a resolution of 600 dpi, collapse of a small-font character occurred. Conceivably, this is due to an insufficient resolution of a resulting image formed through ejection of the ink.

Furthermore, in Comparative Example 2 in which the inkjet head for ejecting the pretreatment liquid and the inkjet head for ejecting the ink both had a resolution of 1200 dpi, while there occurred no collapse of a small-font character, nozzle clogging occurred. Conceivably, this is due to a decrease in diameter of nozzles for ejecting the pretreatment liquid, which makes it likely that clogging of a highly viscous pretreatment liquid occurs.

The results of Disclosure Examples 1 to 4 and Comparative Examples 1 and 2 have confirmed that when the inkjet head for ejecting the pretreatment liquid has a resolution smaller than that of the inkjet head for ejecting the ink, it is possible to suppress nozzle clogging of the inkjet head for ejecting the pretreatment liquid, to reduce the drying time, and to effectively suppress collapse of a small-font character.

The present disclosure is usable in an inkjet recording apparatus that ejects ink onto a recording medium. Through the use of the present disclosure, it is possible to provide an inkjet recording apparatus capable of suppressing repelling or feathering of ink in a case of performing image formation using aqueous ink and also capable of suppressing character collapse.

What is claimed is:

1. An inkjet recording apparatus, comprising:
a conveyance portion that conveys a recording medium;
a recording portion including a recording head that ejects aqueous ink onto the recording medium conveyed thereto by the conveyance portion; and
a pretreatment liquid ejection head that is arranged upstream of the recording portion in a conveyance direction of the recording medium and ejects a pretreatment liquid onto the recording medium by an inkjet method,
wherein
the pretreatment liquid contains at least a binder resin and water, and
where a resolution of the pretreatment liquid ejection head is indicated as A [dpi] and a resolution of the recording head is indicated as B [dpi], a relationship A<B is satisfied.

2. The inkjet recording apparatus according to claim 1, wherein
the pretreatment liquid has a viscosity of not less than 6.0 [mPa·s] and not more than 7.0 [mPa·s].

3. The inkjet recording apparatus according to claim 1, wherein
the resolution B of the recording head is 1200 dpi.

4. The inkjet recording apparatus according to claim 3, wherein
the resolution A of the pretreatment liquid ejection head is 600 dpi.

5. The inkjet recording apparatus according to claim 1, further comprising:
an input portion to which image data is inputted; and
a control portion that controls, based on the image data inputted to the input portion, ejection of the ink onto the recording medium by the recording portion and controls ejection of the pretreatment liquid onto the recording medium by the pretreatment liquid ejection head,
wherein based on the image data, the control portion detects a printing target region on the recording medium, to which the ink is to be ejected by the recording portion, and performs control so that, using the pretreatment liquid ejection head, the pretreatment liquid is ejected only to the printing target region.

6. The inkjet recording apparatus according to claim 1, further comprising:
a heating portion that heats the recording medium when passing through the pretreatment liquid ejection head and the recording portion.

7. The inkjet recording apparatus according to claim 6, wherein
the heating portion includes:
a conveyance plate that supports a surface of the recording medium on an opposite side to the pretreatment liquid ejection head and the recording portion; and
a heater that heats the conveyance plate.

8. The inkjet recording apparatus according to claim 1, wherein
a plastic film is used as the recording medium.
